(19) United States
(12) Patent Application Publication
(10) Pub. No.: US 2004/0256408 A1
(43) Pub. Date: Dec. 23, 2004

(54) Cladding products and methods for making same

(76) Inventor: Lianrui Chen, Tianjin (CN)

Correspondence Address: WINSTON & STRAWN, PATENT DEPARTMENT, 1400 L STREET, N.W., WASHINGTON, DC, 20005-3502, US

(21) Appl. No.: 10/777,051

(22) Filed: Feb. 13, 2004

(30) Foreign Application Priority Data
Jun. 20, 2003 (CN) 03130207.6

(51) Int. Cl. B67B 7/00; G01F 11/00; C25D 5/00

(52) U.S. Cl. 222/1; 205/80

(57) ABSTRACT

A method of forming cladding on products comprises: a shotblasting layer is formed on the basal body of products, i.e., a shotblasting layer of fine and uniform granules is formed on the surface of the basal body of products by shotblasting, and plated layers are plated on the shotblasting layer of the basal body of products, i.e. metal plated layers are plated on the shotblasting layer after the shotblasting layer is formed. A cladding structure on products comprises that a shotblasting layer is remained on the basal body of products, and metal plated layers of a predetermined thickness is provided on the shotblasting layer of the basal body of products. A push rod of a caulking gun with the above cladding structure is also included.

### TECHNICAL FIELD

The present invention relates to a method of forming cladding on metal products or alloy products, and the cladding structure obtained by the method and products with the cladding structure that are especially applicable to cladding of products such as a caulking gun or the parts thereof.

### BACKGROUND OF THE INVENTION

The surface cladding provides products with not only various protections such as corrosion resistance and abrasion resistance, etc., but also the “dress” to attract the favor of the users. Previous disclosure of cladding methods on products and of cladding structure exist. The more progressive ones include the published Chinese patent No. 01806958.4 titled “A Coat with Macroscopic Texture and the Method for Preparing the Same,” which provides a coating basal body comprising a basal body and a radiation curing or heat curing coating on at least a part of the basal body, in which the coating has specific macroscopic texture, and provides a precuring coating mixture comprising radiation or heat curing resins, initiators, and texture-forming particles which have the effective grain size to form the macroscopic texture when the mixture is applied on the basal body, and also provides a process of forming a coating on a basal body which comprises the steps of spreading a precuring coating mixture comprising the radiation curing resin and initiator or the heat curing resin and thermal initiator on at least a part of a basal body to form a precuring coating having the macroscopic texture, and treating the precuring coating with radiation curing or heat curing process respectively to form a radiation curing or heat curing coating with macroscopic texture.

Also included is the published Chinese Patent No. 98114888.3 titled “Products with Coating,” which discloses products having a multi-layer coating of a copper layer, a nickel layer, a chrome layer, a refractory metal layer, preferably a zirconium layer, a composite layer formed by alternate layers of refractory metal compound and refractory metal, a refractory metal compound layer, preferably a zirconium nitride layer, and a refractory metal oxide layer or a layer formed by the reaction product of refractory metal, oxygen and nitrogen.

U.S. Pat. No. 1,802,463 discloses methods for producing chromium plated articles with mirror like or scratch-finished having a thin plate of less than a thousandth of an inch over a substrate of hard metal such as steel. The steel may first be coated with copper before the chromium is applied.

U.S. Pat. No. 2,354,756 discloses a measuring tape with a surface such as a flexible strip of hardened and tempered high carbon spring steel formed by etching or sandblasting or other abrasives to roughen the surface, with various metals applied by electroplating or spraying. These metals can include copper, nickel, chromium, and aluminum, for example. Also disclosed are that a nickel surface is typically the outermost layer of metal or is applied firs when chromium is to cover it.

U.S. Pat. No. 2,835,630 discloses treatment of metals such as by shot blasting with ferrous shot to remove hydrous oxide coatings normally present on certain materials, and then having additional metals including copper and then nickel electrodeposited thereon.

U.S. Pat. No. 3,073,022 discloses various shot peening treatments on metal substrates to provide surface deformations to increase strength and hardness of the metal substrate, preferably with a second shot peening treatment thereover.

U.S. Pat. No. 3,338,803 discloses electroplating of shot peened steel substrates with nickel and chromium, such as 1 mil nickel and 4 mils chromium.

U.S. Pat. No. 3,382,159 discloses metal blasted with glass shot or other dry media to etch the surface with, for example, copper, nickel, and chrome in the case of a zinc-based die cast metal substrate to provide a decorative metal finish.

U.S. Pat. No. 4,426,411 discloses hardened, chrome-plated steel rollers shotblasted with sharp-edged particles and then again with steel balls to round the sharp edges.

The coating structure and method of the above-mentioned techniques is comparatively complicated and is not suitable for manufacturing the common civilian products such as dispensing articles, e.g., a caulking gun. At present, the market demand for common civilian products is that the surface coating should be more novel and attractive to the user, and the manufacturing process should be simpler.

### SUMMARY OF THE INVENTION

The invention encompasses a method for making a dispensing apparatus by providing a shotblasting layer on a portion of a substrate, wherein the shotblasting layer includes a plurality of fine and uniform granules having about 0.3 to 0.6 mm and about 0.14 to 0.5 mm grain sizes at a velocity of at least about 50 m/s, and providing a plurality of metal plated layers over the shotblasting layer, wherein the shotblasting layer and metal plated layers together are present in an amount and thickness sufficient to increase the corrosion and abrasion resistance of the substrate and wherein the substrate forms a portion of the dispensing apparatus.

In one embodiment, the providing of the plated metal layers includes plating a copper layer first, then a nickel layer, and then a chrome layer. In a preferred embodiment, the plurality of plated metal layers collectively has a thickness of about 15.3 to 30.3 μm. In one embodiment, the substrate includes a push rod. The shotblasting layer and the metal plated layers together provide a reduced-friction coating that facilitates extrusion of a flowable pasty substance from the dispensing apparatus. In another embodiment, the dispensing apparatus is a caulk gun or a portion thereof.

The invention also relates to an apparatus including a substrate with a shotblasted layer disposed over a portion thereof, and a plurality of plated layers disposed over a portion of the shotblasted layer, wherein the plated layers are successively a copper layer, a nickel layer and a chrome layer. In one embodiment, the substrate includes a push rod that is capable of dispensing a flowable substance. In a preferred embodiment, the apparatus includes a dispensing device, typically for dispensing a flowable pasty substance. In a more preferred embodiment, the apparatus includes a caulk gun or a portion thereof.

Preferably, the shotblasting layer is about 8 to 12 μm in thickness. In another embodiment, the plated layers are collectively about 15.3 to 30.3 μm in thickness. In a preferred embodiment, the plated layers successively include a copper layer of about 10 to 20 μm in thickness, a nickel layer of about 5 to 10 μm in thickness, and a chrome layer of about 0.1 to 0.5 μm, preferably about 0.3 μm in thickness.

The invention also relates to an improvement in a caulking apparatus having a chamber configured and dimensioned to receive flowable pasty material and a push rod operatively associated with the chamber to facilitate extrusion of the flowable pasty material, wherein the improvement involves providing a cladding structure to a portion of the push rod which includes a shotblasted layer disposed over a portion of the push rod, and a plurality of metal plated layers of a predetermined thickness provided over a portion of the shotblasted layer.

In one embodiment, the nickel layer is disposed between the copper layer and the chrome layer. In another embodiment, the chrome layer is disposed over a portion of the copper layer and the nickel layer. In yet another embodiment, the plated layers are successively disposed with the copper layer being adjacent to the substrate, with the nickel layer being disposed on the copper layer, and the chrome layer being disposed on the nickel layer. Each of the above-described embodiments in this Summary applies to each aspect of the invention.

### BRIEF DESCRIPTION OF DRAWINGS

Further features and advantages of the invention can be ascertained from the following detailed description that is provided in connection with the drawing(s) described below:

FIG. 1 is a schematic representation of the cladding structure according to the present invention.

FIG. 2A is a schematic representation of the structure of a push rod of a caulking gun according to the present invention.

FIG. 2B is a sectional schematic representation of part of the push rod of a caulking gun according to the present invention.

### DETAILED DESCRIPTION OF THE PREFERRED EMBODIMENTS

The present invention intends to overcome the above defects existing in the related art, and provides a method of forming cladding on products, a cladding structure of products by the method, and a push rod of an apparatus such as a dispensing article or caulking gun.

The method of the present invention adopts the following technical solution to solve technical problems. The method of forming cladding on products according to the present invention comprises: a shotblasting layer is formed on the basal body of products, i.e. a shotblasting layer of fine and uniform granules is formed on the surface of the basal body of products by shotblasting; and plated layers are plated on the shotblasting layer of the basal body of products, i.e., metal plated layers are plated on the shotblasting layer after the shotblasting layer is formed. The terms “basal body” and “substrate” are used synonymously herein.

The fine and uniform granules of the shotblasting can be directed at the substrate to form a shotblasting, or shotblasted, layer. These granules are preferably steel pellets having a grain size of about 0.3 to 0.6 mm and stainless steel sand pellets having a grain size of about 0.14 to 0.5 mm grain size. Any mixture or alloy of steel or stainless steel pellets can be used. In one embodiment, all pellets are within about 0.1 mm diameter size of each other to provide a more uniform surface. The pellets are directed at the substrate, such as by shooting off, at a line speed of at least about 50 m/s, preferably about 55 to 100 m/s, and more preferably at about 62 m/s to 68 m/s. The shotblasting of the substrate should be sufficiently long to provide a suitable shotblasting layer to facilitate formation of a reduced-friction coating on the substrate. Thus, the sufficiently long time is preferably at least about 5 minutes, preferably from about 10 minutes to 45 minutes, and more preferably from about 15 minutes to 20 minutes. An exemplary firing speed is about 64.22 m/s, particularly when the shotblasting occurs over about 18 minutes.

The method of the present invention adopts further the following technical solution to solve technical problems. In the method of forming cladding on products, the said plated layers forming on the shotblasting layer comprises plating a copper layer first, then a nickel layer followed by a chrome layer.

The cladding structure of products of the present invention adopts the following technical solution to solve technical problems. The cladding structure of products comprises a basal body and plated layers, wherein a shotblasting layer is remained on the basal body of products, and metal plated layers of a predetermined thickness are provided on the shotblasting layer of the basal body of products.

The cladding structure of products of the present invention adopts further the following technical solution to solve technical problems. In the above cladding structure of products, the shotblasting layer is about 8 to 12 μm in thickness, the plated layers are about 15.3 to 30.3 μm in thickness in total, and the plated layers consist successively of a copper layer of about 10 to 20 μm in thickness, a nickel layer of about 5 to 10 μm in thickness and a chrome layer of about 0.1 to 0.5 μm, preferably about 0.3 μm in thickness.

The push rod of an apparatus such as a dispensing article or caulking gun of the present invention adopts the following technical solution to solve technical problems. The push rod includes a basal body (1) of the push rod, wherein a shotblasting layer (11) is formed on the basal body of the push rod, plated layers are plated on the shotblasting layer (11), and the said plated layers are successively a copper layer (12), a nickel layer (13) and a chrome layer (14).

In the above push rod, the shotblasting layer is 8 to 12 μm in thickness, the plated layers are 15.3 to 30.3 μm in thickness in total, the plated layers consist successively of a copper layer of 10 to 20 μm in thickness, a nickel layer of 5 to 10 μm in thickness and a chrome layer of 0.3 μm in thickness.

Compared with the prior art, the present invention has remarkable advantages and beneficial effects. It can be seen from the above technical solution that the present invention with excellent structure configuration has at least the following advantages. The present invention is suitable to the surface cladding of products which can improve the corrosion resistance and abrasion resistance of products and make the products having more aesthetic feelings, novel and acceptable to the users. The manufacturing process is simple and is easier to industrial implementation. Thus the invention is a fine technique having the novelty, inventiveness and applicability.

The term “about,” as used herein, should generally be understood to refer to both numbers in a range of numerals. Moreover, all numerical ranges herein should be understood to include each whole integer within the range.

### EXAMPLES

The specific embodiments, structure, characters and effects of the present invention will be explained in detail with reference to the accompanying drawings and the following preferred examples.

### Example 1

### Forming a Cladding Layer According to the Invention

In a method of forming cladding on products, a shotblasting layer (11) was formed on the basal body (1) of products, i.e. a shotblasting layer (11) of fine and uniform granules was formed on the surface of the basal body (1) of products by shotblasting; and plated layers were formed on the shotblasting layer (11) of the basal body (1) of products, i.e. metal plated layers were plated on the shotblasting layer (11) after the shotblasting layer (11) was formed.

### Example 2

### Forming a Cladding Layer According to the Invention

In another method of forming cladding on products, a shotblasting layer (11) was formed on the basal body (1) of products, i.e. a shotblasting layer (11) of fine and uniform granules was formed on the surface of the basal body (1) of products by shotblasting; and the shotblasting layer (11) was preferably 8 to 12 μm in thickness; plated layers were formed on the shotblasting layer (11) of the basal body (1) of products, i.e. metal plated layers were plated on the shotblasting layer (11) after the shotblasting layer (11) was formed, the plated layers were preferably 15.3 to 30.3 μm in thickness in total, and the plated layers consisted successively of a copper layer (12) of 10 to 20 μm in thickness, a nickel layer (13) of 5 to 10 μm in thickness and a chrome layer (14) of 0.3 μm in thickness preferably.

### Example 3

### A Cladding Structure According to the Invention

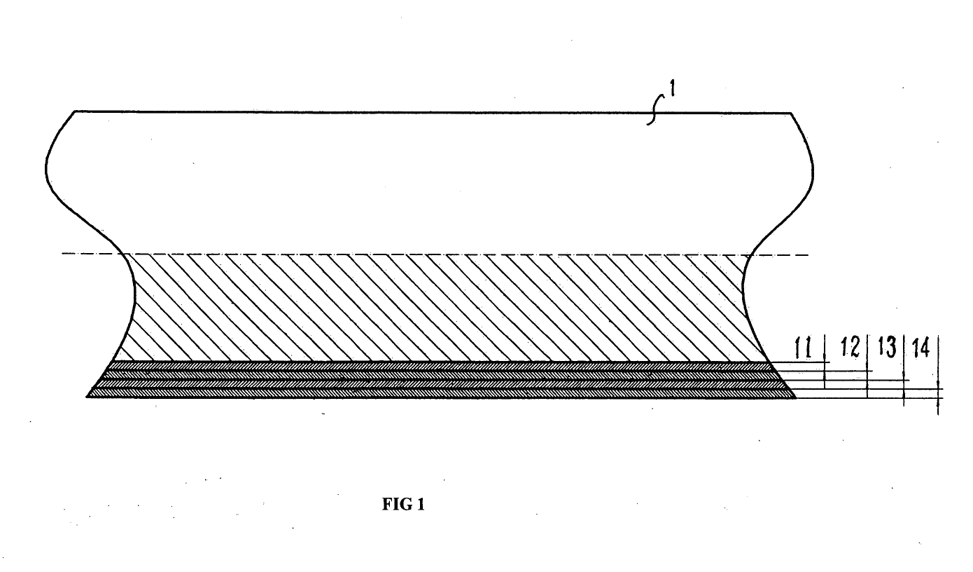

FIG. 1 shows the cladding structure according to the present invention. On the basal body (1) of products, a shotblasting layer with fine and uniform granules was formed using the known method of shotblasting and was 8-12 μm in thickness, thereby the microscopic hardness was higher than that of the original surface of the basal body.

On the shotblasting layer (11) of the basal body of products, metal plated layers with a predetermined thickness was plated by the known process of plating. The metal plated layers were successively a copper layer (12), a nickel layer (13) and a chrome layer (14). The plated layers were preferably 15.3 to 30.3 μm in thickness in total, and the plated layers consisted successively of a copper layer (12) of 10 to 20 μm in thickness, a nickel layer (13) of 5 to 10 μm in thickness and a chrome layer (14) of 0.3 μm in thickness preferably.

### Example 4

### A Push Rod Having a Cladding Layer According to the Invention

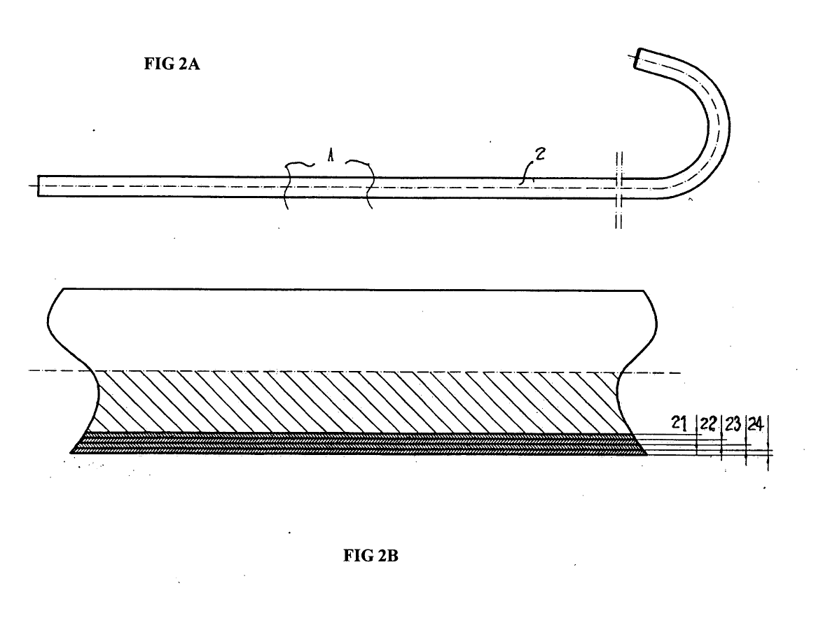

FIGS. 2A and 2B shows the structure of a push rod of a dispensing article, such as a caulking gun according to the present invention. For a push rod of a dispensing article, such as a calking gun, with cladding, a shotblasting layer (21) was formed on the basal body (2) of a push rod and a plating coat was plated on the shotblasting layer (21). The plating coat consisted successively of a copper layer (22), a nickel layer (23) or a chrome layer (24). The plating coat was preferably 15.3 to 30.3 μm in thickness in total, and the plated coat consisted successively of a copper layer (12) of 10 to 20 μm in thickness, a nickel layer (13) of 5 to 10 μm in thickness and a chrome layer (14) of 0.3 μm in thickness preferably.

While the invention has been shown and described with reference to certain preferred embodiments thereof, it will be understood by those skilled in the art that various changes in form and details may be made therein without departing from the spirit and scope of the invention as defined by the appended claims. The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art. Thus, it is intended that the present invention cover the modifications and variations of this invention provided they come within the scope of the appended claims and their equivalents.

What is claimed is:

1. A method for making a dispensing apparatus portion which comprises:
providing a shotblasting layer onto a portion of a substrate so as to compress the surface thereof, wherein the shotblasting layer is provided by a plurality of fine and uniform granules of steel pellets having a grain size of about 0.3 to 0.6 mm and stainless steel pellets having a grain size of about 0.14 to 0.5 mm at a velocity of at least about 50 m/s; and
providing a plurality of metal plated layers over the shotblasting layer, wherein the shotblasting layer and metal plated layers together are present in an amount and thickness sufficient to increase the corrosion and abrasion resistance of the substrate and wherein the substrate forms a portion of the dispensing apparatus.

2. The method of claim 1, wherein the providing of the plated metal layers comprises plating a copper layer first, then a nickel layer, and then a chrome layer.

3. The method of claim 2, wherein the plurality of plated metal layers collectively has a thickness of about 15.3 to 30.3 μm.

4. The method of claim 1, wherein the substrate comprises a push rod that is adapted to contact a dispensable material.

5. The method of claim 4, wherein the shotblasting layer and the metal plated layers together provide a reduced-friction coating that facilitates extrusion of a flowable pasty substance from the dispensing apparatus.

6. An apparatus comprising:
a substrate with a shotblasted layer on a portion of a surface thereof; and
a plurality of plated layers disposed over the shotblasted layer,
wherein the plated layers are successively a copper layer, a nickel layer and a chrome layer.

7. The apparatus of claim 6, wherein the substrate comprises a push rod capable of dispensing a flowable substance.

8. The apparatus of claim 6, wherein the shotblasted layer is about 8 to 12 μm in thickness.

9. The apparatus gun of claim 6, wherein the plated layers are collectively about 15.3 to 30.3 μm in thickness.

10. The apparatus of claim 6, wherein the plated layers comprise successively of a copper layer of about 10 to 20 μm in thickness, a nickel layer of about 5 to 10 μm in thickness, and a chrome layer of about 0.1 to 0.5 μm in thickness.

11. The apparatus of claim 6, wherein the apparatus comprises a dispensing article.

12. The apparatus of claim 6, wherein the dispensing article comprises a caulk gun or portion thereof.

13. A dispensing apparatus having a chamber configured and dimensioned to receive flowable pasty material and a push rod operatively associated with the chamber to facilitate extrusion of the flowable pasty material, wherein the improvement comprises providing a cladding structure to a portion of the push rod which comprises:
a shotblasted layer over a portion of a surface of the push rod; and
a plurality of metal plated layers of a predetermined thickness provided over a portion of the shotblasted area.

14. The dispensing apparatus of claim 13, wherein the shotblasted layer is about 8 to 12 μm in thickness.

15. The dispensing apparatus of claim 13, wherein the plurality of plated layers are collectively about 15.3 to 30.3 μm in thickness.

16. The dispensing apparatus of claim 13, wherein the plated layers comprise a copper layer of about 10 to 20 μm in thickness, a nickel layer of about 5 to 10 μm in thickness, and a chrome layer of about 0.1 to 0.5 μm in thickness.

17. The dispensing apparatus of claim 16, wherein the nickel layer is disposed between the copper layer and the chrome layer.

18. The dispensing apparatus of claim 16, wherein the chrome layer is disposed over a portion of the copper layer and the nickel layer.

19. The dispensing apparatus of claim 16, wherein the plated layers are successively disposed with the copper layer being adjacent to the substrate, with the nickel layer being disposed on the copper layer, and the chrome layer being disposed on the nickel layer.

20. The dispensing apparatus of claim 16, wherein the dispensing apparatus comprises a caulk gun and the flowable pasty material comprises caulk.
